(19) United States
(12) Patent Application Publication
(10) Pub. No.: US 2015/0358792 A1
(43) Pub. Date: Dec. 10, 2015

(54) WIRELESS COMMUNICATION SYSTEM, PAIRING APPARATUS, METHOD FOR PAIRING PLURAL DEVICES AND PROGRAM FOR CAUSING COMPUTER TO IMPLEMENT THAT METHOD

(71) Applicant: SHARP KABUSHIKI KAISHA, Osaka-shi, Osaka (JP)

(72) Inventors: Toshikazu HASHIMOTO, Osaka-shi (JP); Taichiro MORISHITA, Osaka-shi (JP); Koji KAWADA, Osaka-shi (JP)

(21) Appl. No.: 14/381,458

(22) PCT Filed: Mar. 7, 2014
(86) PCT No.: PCT/JP2014/055918

§ 371 Date: Aug. 27, 2014

(30) Foreign Application Priority Data
Aug. 6, 2013 (JP) 2013-163347

(51) Int. Cl. H04W 4/20; H04W 4/08

(52) U.S. Cl. CPC H04W 4/206; H04W 4/08

(57) ABSTRACT

A wireless communication system with increased convenience of pairing is provided. A hard disk of a management server forming the wireless communication system includes a database having pairing information. The database includes pairing information and terminal device user information. The pairing information includes a terminal ID and a device ID. The terminal device user information includes a terminal ID or device ID, and a common ID. A terminal ID of a first terminal, a terminal ID of a second terminal, a device ID of a first device, and a device ID of a second device are associated with one another via a common ID. The common ID is a value defined in a filed of the common ID of the terminal device user information.

### TECHNICAL FIELD

The present disclosure relates to pairing of wireless communication devices:, and more particularly to setting or deletion of pairing.

### BACKGROUND ART

A network using devices having a wireless communication function is in widespread use. The devices need to he previously paired together in order to establish wireless communication.

With regard to pairing, Japanese Patent Laying-Open No. 2008-047022 (PTD 1), for example, discloses “an information sharing system by portable terminal devices,” According to a technique disclosed in PTD 1, “To a server device 200, a terminal registration unit 111 requests the registration of its own identification information, a shared information registration unit 113 requests the registration of its own user information, a pairing registration unit 112 requests the shared registration of the above user information with another portable terminal device 100 whose identification information has been registered, and a shared information reference unit 114 requests a reference to user information about another portable terminal device 100 whose user information has been authorized to be shared, whereas to server device 200, a terminal registration unit 209 registers portable terminal device 100, a shared information registration unit 211 registers user information, a pairing registration unit 210 authorizes the shared authorization of the user information, and a shared information reference unit 212 authorizes a reference to the user information.” (see [Abstract])

Japanese Patent Laying-Open No. 2012-080482 (PTD 2) discloses a technique for “linking a mobile terminal and a device together through a server by device specifying information and a riser's input operation.” According to the technique disclosed in PTD 2, “After a server 101 confirms location information shout a mobile terminal 103, a living room device 106, a bedroom device 107 and another regional device 109, and specifies a device located in the same position as mobile terminal 103, server 101 determine an operation command in consideration of a state of the specified device, transmits a command waiting instruction to the specified device, and informs the mobile terminal of a command to be presented to a user, the mobile terminal presents the command to the user, and the device provided with the command waiting instruction informs the server, upon receiving a correct command from the user, that the command has been received, whereby the mobile device and the terminal and the server are associated together.” (see [Abstract])

### CITATION LIST

### Patent Documents

PTD 1: Japanese Patent Laying-Open No. 2008-047022

PTD 2: Japanese Patent Laying-Open No. 2012-080482

### SUMMARY OF INVENTION

### Technical Problem

However, devices to be paired together have conventionally been directly linked together. Thus, even devices owned by the same user need to be linked together for each combination of the devices in order to perform operation of for example, referring to or deleting data, resulting in a lack of convenience.

Furthermore, an environment dining execution of pairing (e.g., whether the devices are inside a house) has not been considered. Thus, if a third party could know the presence of devices and information necessary for connection (IP (Internet Protocol) addresses), there is a high risk that pairing is completed without the knowledge of a legal user, or that devices which are candidates for pairing are operated without authorization.

Accordingly, there is a need for a technique of increasing the convenience of pairing. In another aspect, there is a need for a technique of preventing unintended use of devices which are candidates for pairing.

The present disclosure was made to solve the problems as described above, and an object in one aspect is to provide a wireless communication system with increased convenience of pairing. As object in another aspect is to provide a wireless communication system that prevents unintended use of devices which are candidates for pairing.

An object in another aspect is to provide a pairing apparatus with increased convenience of pairing. An object in another aspect is to provide a pairing apparatus that prevents unintended me of devices which are candidates for pairing.

An object in another aspect is to provide a method for associating a plurality of devices together with increased convenience of pairing. An object in yet another aspect is to provide a method for associating a plurality of devices together while preventing unintended use of devices which are candidates for pairing.

An object in yet another aspect is to provide a program for causing one or more processors to implement a method for associating a plurality of devices together with increased convenience of pairing. An object in yet another aspect is to provide a program for causing one or more processors to implement a method for associating a plurality of devices together while preventing unintended rise of devices which are candidates for pairing.

### Solution to Problem

A wireless communication system according to one embodiment includes a plurality of devices connected to a network, and a management server connected to the network. The management server includes a reception unit configured to receive identification information about a first device and identification information, about a second device oft he plurality of devices, pairing identification information for specifying pairing of the first device and the second device, and a pairing request, and a pairing unit configured to associate, based on the pairing request, the pairing identification information with the identification information about the first device and the identification Information about the second device.

According to another embodiment, a pairing apparatus for associating a plurality of devices together is provided. The pairing apparatus includes a reception unit configured to receive identification information about a first device and identification information about a second device of the plurality of devices connected to a network pairing identification information for specifying pairing, and a pairing request, and a pairing unit configured to associate, based on the pairing request, the pairing identification information with the identification information, about the first device and the identification information about the second device.

According to another embodiment, a method for pairing a plurality of devices together by a processor is provided. This method includes the steps of receiving identification information about each of the devices, associating data common to the devices with the identification information about each of two of the plurality of devices, and transmitting information indicating the association between the common data and the identification information about each of the two devices to the two devices.

According to another embodiment, a program for causing one or more processors to implement a method for pairing a plurality of devices together is provided. This program causes the one or more processors to perform the steps of receiving identification information about each of the devices, associating data common to the devices with the Identification information about each of two of the plurality of devices, and transmitting information indicating the association between the common data and the identification information about each of the two devices to the two devices.

The foregoing and other objects, features, aspects and advantages of the present invention will become more apparent front the following detailed description of the present invention when taken in conjunction with the accompanying drawings.

### BRIEF DESCRIPTION OF DRAWINGS

FIG. 1 is a diagram illustrating a configuration of a network system 100.

FIG. 2 is a diagram conceptually illustrating a configuration of a network system 200.

FIG. 3 is a diagram illustrating a form of a network system 310.

FIG. 4 is a block diagram illustrating a hardware configuration of a communication terminal 400.

FIG. 5 is a diagram illustrating one example of a list 500 displayed on a monitor 35.

FIG. 6 is a block diagram illustrating a hardware configuration of a management server 300.

FIG. 7 is a block, diagram illustrating a configuration, of functions implemented by management server 300.

FIG. 8 is a diagram conceptually illustrating one form of data stored in a hard disk 5 included in management server 300.

FIG. 9 Is a flowchart Illustrating part of processing executed by communication terminal 400 and management server 300.

FIG. 10 is a diagram illustrating a transition of screens displayed on monitor 35.

FIG. 11 is a flowchart illustrating pan of processing executed by management server 300 in order to register a common ID.

FIG. 12 is a flowchart illustrating part of processing executed by communication terminal 400.

FIG. 13 is a flowchart illustrating part of pairing processing executed by management server 300.

FIG. 14 is a diagram illustrating a form in which data is referred to via a common ID 840 by a not directly paired terminal as well.

FIG. 15 is a flowchart illustrating part of processing executed between a second terminal 120 and a first device 130.

FIG. 16 is a diagram illustrating a form in which pairing of a terminal and a device that have been paired together is deleted.

FIG. 17 is a flowchart illustrating part of processing executed by second terminal 120 which is one communication terminal 400 and management server 300.

FIG. 18 is a flowchart illustrating part of processing executed by a CPU 1 of management server 300.

FIG. 19 is a diagram illustrating authority regarding deletion of pairing.

FIG. 20 is a diagram illustrating a form in which pairings are collectively deleted in a paired state.

FIG. 21 is a flowchart illustrating part of processing executed by management server 300 in order to delete pairing.

FIG. 22 is a diagram illustrating one example of a screen displayed on monitor 35.

### DESCRIPTION OF EMBODIMENTS

Embodiments of the present invention will be described hereinafter with reference to the drawings. In the following description, the same components are given the same numerals, and their names and functions are also identical. Accordingly, the description thereof is not repeated.

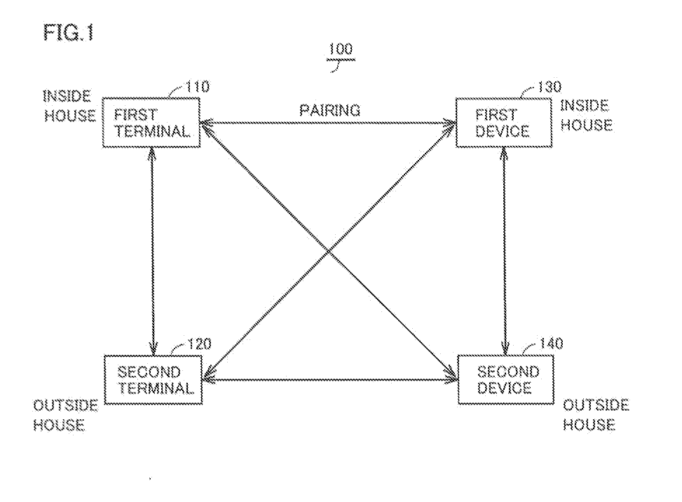

Referring to FIG. 1, a configuration of a network, system in one aspect is described. FIG. 1 is a diagram Illustrating a configuration of a network system 100. Network system 100 includes a first terminal 110, a second terminal 120, a first device 130, and a second device 140. First terminal 110 is paired with first device 130 and second device 140. Second terminal 120 is paired with first device 130 and second device 140. First terminal 110 and second terminal 120 are paired together. First device 130 and second device 140 are paired together.

It is noted that terminal and device are distinctively used in the following embodiments for clarity of explanation. Both terminal and device are implemented through a unit having at least a wireless communication function and an information processing function.

### Embodiment 1

[Configuration of Network System]

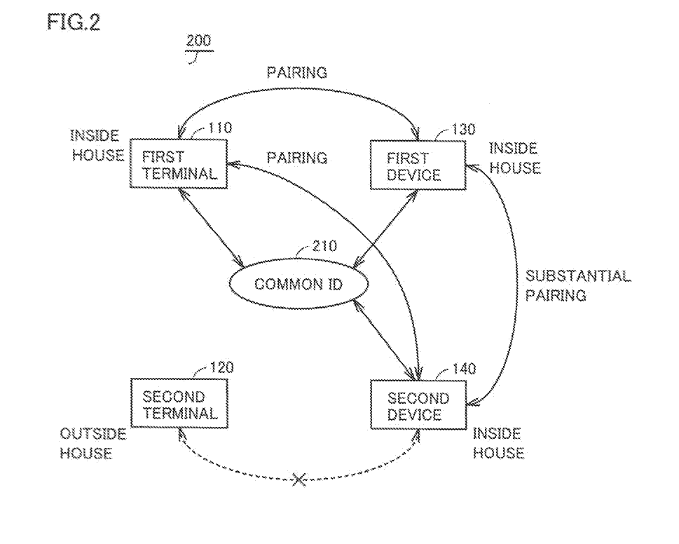

Referring to FIG. 2, a network system 200 according to Embodiment 1 is described. FIG. 2 Is a diagram conceptually illustrating a configuration of network system 200.

In one aspect, network system 100 includes first terminal 110, first device 130, and second device 140. First terminal 110, first device 130, and second device 140 are paired with one another via a common ID 210.

On the other hand, second terminal 120 exists, for example, outside a house in which network system 200 is constructed, and second terminal 120 is not paired with another device, for example, second device 140.

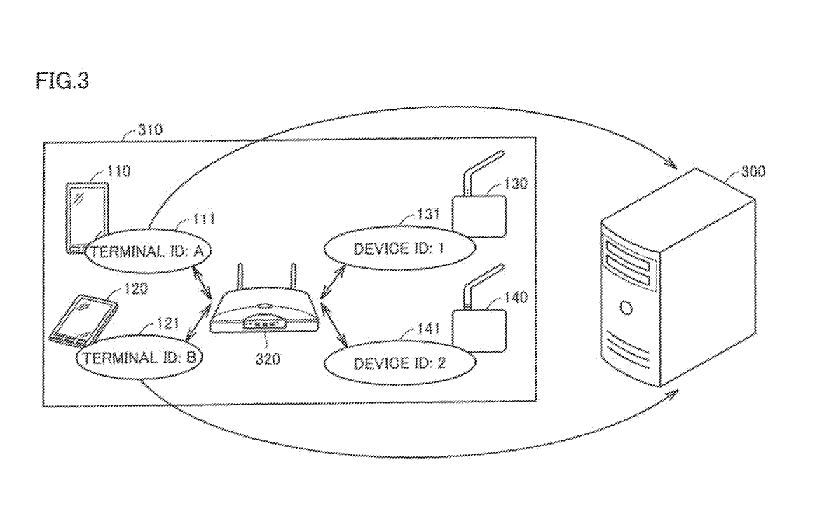

Referring to FIG. 3, the network system according to this embodiment is further described. FIG. 3 is a diagram illustrating a form of a network system 310.

Network system 310 is connected to a management server 300. Network system 310 includes first terminal 110, second terminal 120, first device 130, second device 140, and an access point 320. First terminal 110 has a terminal ID (A) 111. Second terminal 120 has a terminal ID (B) 121. First device 130 has a device ID (1) 131. Second device 140 has a device ID (2) 141.

First terminal 110, second terminal 120, first device 130, and second device 140 are connected to be capable of communicating with, one another via access point 320. Access point 320 is implemented through a router or another relay device for implementing a wireless LAN.

[Hardware Configuration]

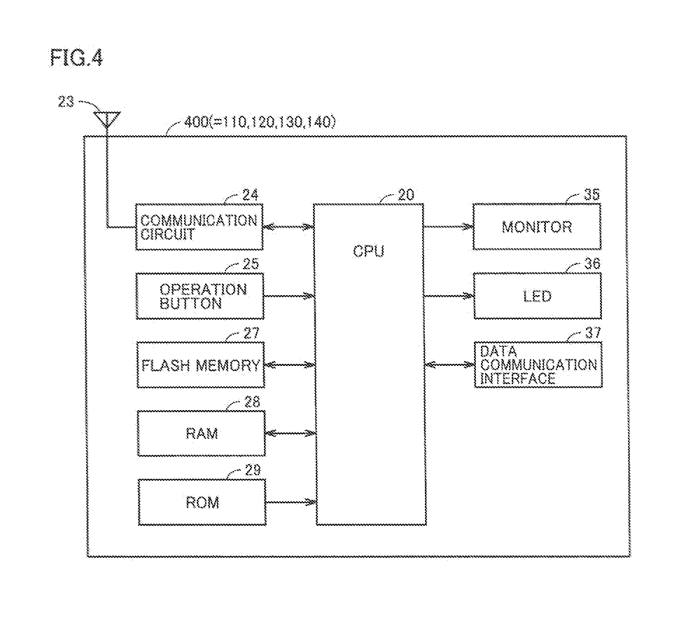

Referring to FIG. 4, a configuration of a communication terminal 400 according to this embodiment is described. FIG. 4 is a block diagram illustrating a hardware configuration of communication terminal 400. Here, communication terminal 400 is a generic terra used to refer to first terminal 110, second terminal 120, first device 130, second device 140, and other communication terminals.

Communication terminal 400 is, but not limited to, a mobile telephone, a tablet terminal, an air conditioner, a personal computer, a television, or a Blu-ray recorder, for example. Communication terminal 400 is only required to be a terminal having at least a wireless communication function and an information processing function.

Communication terminal 400 includes a CPU 20, an antenna 23, a communication circuit 24, an operation button 25, a flash memory 27, a RAM (Random Access Memory) 28, a ROM (Read Only Memory) 29, a monitor 35, an LED (Light Emitting Diode) 36, and a data communication interface 37.

Antenna 23 receives a signal transmitted from the access point or other wireless communication terminals, or transmits a signal for communicating with other wireless communication terminals via the access point or a signal for directly communicating with the other wireless communication terminals. The signal received by antenna 23 is subjected to front end processing by communication circuit 24, and the processed signal is transmitted to CPU 20.

Operation button 25 accepts operation of communication terminal 400. Operation button 25 is implemented through, for example, a hard key or a soft key. A combination of a hard key and a soft key may be employed. Upon accepting the operation, operation button 25 transmits a signal according to an operation mode of communication terminal 400 of that time to CPU 20.

CPU 20 executes processing for controlling the operation of communication terminal 400 based on an instruction provided to communication terminal 400. When communication terminal 400 receives a signal, CPU 20 executes predefined processing, based on a signal transmitted from communication circuit 24.

CPU 20 converts information to be transmitted to other wireless communication terminals into data for transmission, and transmits the converted data to communication circuit 24. Communication circuit 24 generates a signal for transmission using that data, and transmits the signal toward antenna 23. The other wireless communication terminals can communicate with communication terminal 400 by receiving the signal.

Flash memory 27 stores data transmitted, from CPU 20. CPU 20 reads the data stored in flash memory 27, and executes predefined processing using the data.

RAM 28 temporarily holds data which is generated by CPU 20 based on the operation performed on operation button 25.

ROM 29 stores a program or data for causing communication terminal 400 to perform predefined operation. CPU 20 reads the program or data from ROM 29, and controls the operation of communication terminal 400.

Monitor 35 is a touch panel display, and a touch panel mechanism is not particularly limited. Monitor 35 displays an image defined by data which is obtained from CPU 20. For example, monitor 35 displays data stored in flash memory 27 (e.g., data indicating a state of communication, terminal 400, operating history, performance time, etc.).

LED 36 implements predetermined light-emitting operation based on a signal from CPU 20. Data communication interface 37 accepts mounting of a data communication cable.

Data communication interface 37 transmits a signal output from CPU 20 to the cable. Alternatively, data communication interface 37 transmits data received through the cable to CPU 20.

Where communication terminal 400 is a smartphone or another mobile telephone, communication terminal 400 includes components usually included is a mobile telephone, such, as a microphone and a speaker. Where communication terminal 400 is an air conditioner, communication terminal 400 includes components usually included in an air conditioner, such as a remote control signal receiver and a temperature adjusting function. The same applies where communication terminal 400 is a personal computer, a television, a Blu-ray recorder or the like.

[Overview of Operation of Communication Terminal 400]

In one aspect, communication terminal 400 operates as a pairing apparatus for associating a plurality of devices together. An example where communication terminal 400 is first terminal 110 is described below.

(1) Specifically, CPU 20 receives identification information about a first device (e.g., first terminal 110) and identification information about a second device (first device 130) of the plurality of devices connected to the network, pairing identification information for specifying pairing, and a pairing request, through communication circuit 24. CPU 20, as a pairing processing unit, associates the pairing identification information with the identification information about the first device and the identification information about the second device based on the pairing request.

(2) in another aspect, CPU 20 transmits information about a device that can be paired with the first device to the first device through data communication interface 37.

(3) In another aspect, where the second device is the device that can be paired, CPU 20, as a pairing processing unit, associates the pairing identification information with the identification, information about the first device and the identification information about the second device.

(4) In another aspect, CPU 20 receives a network address of the first device. Where the first device and the second device exist in the same network, CPU 20, as a pairing processing unit, associates the pairing identification information with the identification information about the first device and the identification information about the second device.

(5) In another aspect, CPU 20, as a pairing deletion unit, cancels the association between the pairing identification information, and the identification information about the first device and the identification, information about the second device.

(6) In another aspect, where another one of the plurality of devices and the second device have been paired together via the pairing identification information, CPU 20, as a pairing deletion unit, cancels the pairing of the another device and the second device.

[Display Form]

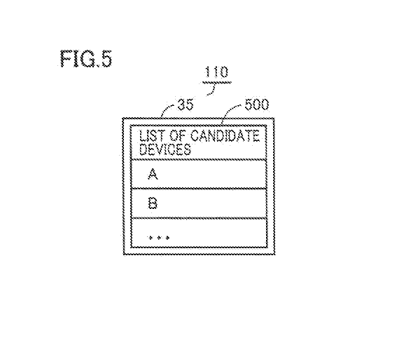

Referring to FIG. 5, a display form of a screen of communication terminal 400 is described. FIG. 5 is a diagram illustrating one example of a list 500 displayed on monitor 35. In one aspect, list 500 displays a list of devices which are candidates for pairing. For example, identification information about first terminal 110 (device ID=A), identification information about second terminal 120 (device ID=B) and the like are displayed as devices that can he paired with first device 130.

[Hardware Configuration of Management Server 300]

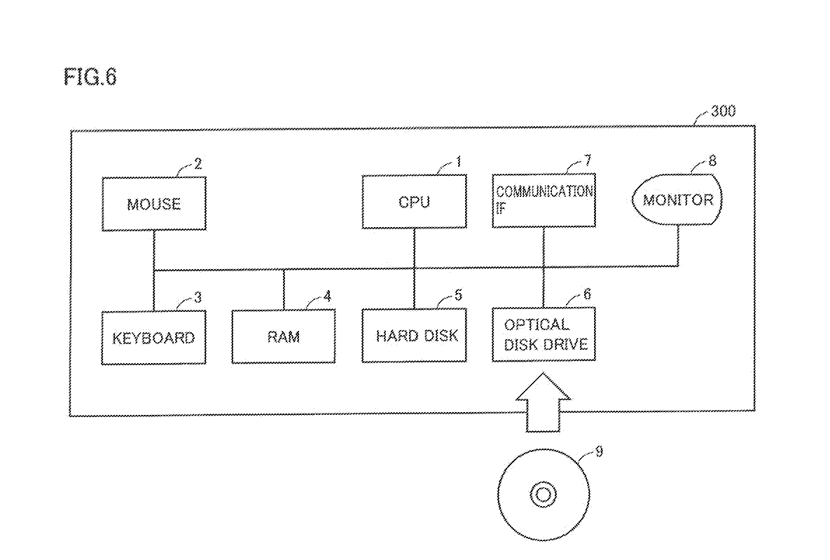

Referring to FIG. 6, a configuration of management server 300 according to this embodiment is described. FIG. 6 is a block diagram illustrating a hardware configuration of management server 300. In one aspect, management server 300 is implemented through a general purpose computer having a well-known configuration. Management server 300 is operated by, for example, a home network service provider.

More specifically, management server 300 includes, as main components, a CPU (Central Processing Unit) 1 for executing a program, a mouse 2 and a keyboard 3 for receiving input of an instruction from a user of management server 300, a RAM 4 storing in a volatile manner data generated by CPU 1 executing the program, or data input via mouse 2 or keyboard 3, a hard disk 5 storing data in a nonvolatile manner, an optical disk drive 6, a communication IF (Interlace) 7, and a monitor 8. These components are interconnected via a bus. Optical disk drive 6 has a CD-ROM 9 or another optical disk mounted thereon. Communication interface 7 includes, but is not limited to, a USB (Universal Serial Bus) interface, a wired LAN (Local Area Network), a wireless LAN, a Bluetooth® interface or the like.

The processing in management server 300 is implemented through each hardware component and software executed by CPU 1. Such software may be previously stored in hard disk 5. Alternatively, the software may be stored in CD-ROM 9 or another computer readable nonvolatile data recording medium, and distributed as a program product. Alternatively, the software may be provided as a downloadable program product by an information provider connected to the Internet or another network. Such software is read from the data recording medium by optical disk drive 6 or another data reader, or is downloaded through communication interface 7, and is then temporarily stored in hard disk 5. The software is read from hard disk 5 by CPU 1, and stored in the form of an executable program in RAM 4. CPU 1 executes the program.

The components forming management server 300 shown in FIG. 6 are general components. Accordingly, it can be said that the most essential part according to this embodiment is the program stored in management server 300. Since the operation of each hardware component of management server 300 is well known, the description thereof is not repeated.

It is noted that the data recording medium is not limited to a CD-ROM, an FD (Flexible Disk), or a hard disk, but may be a nonvolatile data recording medium that holds a program fixedly instead of temporarily, such as a magnetic tape, a cassette tape, an optical disk (MO (Magnetic Optical Disc)/MD (Mini Disc)/DVD (Digital Versatile Disc)), an IC (Integrated Circuit) card (including a memory card), an optical card, and a semiconductor memory such as a mask ROM, an EPROM (Electronically Programmable Read-Only Memory), an EEPROM (Electronically Erasable Programmable Read-Only Memory), and a flash ROM.

The program as used herein may include not only a program directly executable by the CPU but also a program in the form of a source program, a compression-processed program, an encrypted program and die like.

[Overview of Operation of Management Server 300]

(1) In one aspect, CPU 1 of management server 300 receives identification information about a first device and identification information about a second device of the plurality of devices, pairing identification information for specifying pairing of the first device and the second device, and a pairing request, through communication interface 7. CPU 1 associates, based on, the pairing request, the pairing identification information with the identification information about the first device and the identification information about the second device.

(2) In another aspect, CPU 1 transmits information about a device (e.g., second terminal 120, first device 130, second device 140) (an ID of the device or another information for identifying the device) that can be paired with the first device (e.g., first terminal 110) to the first device through, communication Interface 7.

(3) In another aspect, where the second device (e.g., a terminal or a device other than first terminal 110) is the device that can be paired, CPU 1 associates the pairing identification information with the identification information about the first device and the identification information about the second device.

(4) In another aspect, CPU 1 receives a network address of the first device through communication interface 7. Where the first device and the second device exist in the same network, CPU 1 associates the pairing identification information with the identification information about the first device and the identification information about the second device.

(5) In another aspect, CPU 1 cancels the association between the pairing identification information, and the identification information about the first device and the identification information about the second device, in order to delete the pairing.

(6) In another aspect, where another one of the plurality of devices and the second device have been paired together via the pairing identification information, CPU 1 cancels the pairing of the another device and the second device.

[Functional Configuration]

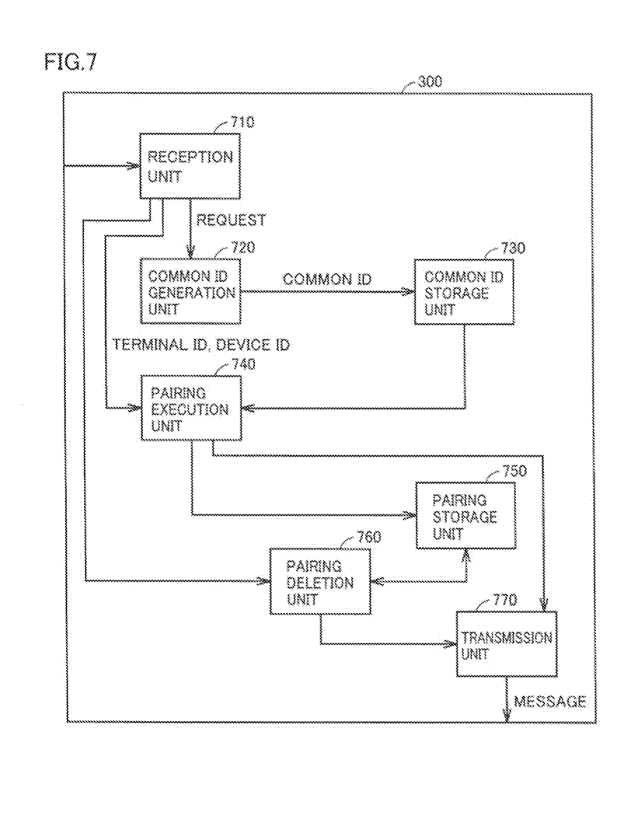

Referring to FIG. 7, the configuration of management server 300 according to this embodiment is further described. FIG. 7 is a block diagram illustrating a configuration of functions implemented by management server 300. Management server 300 includes a reception unit 710, a common ID generation unit 720, a common ID storage unit 730, a pairing execution unit 740, a pairing storage unit 750, a pairing deletion unit 760, and a transmission unit 770.

Reception unit 710 and transmission unit 770 are implemented through communication interface 7. Common ID generation unit 720, pairing execution unit 740 and pairing deletion unit 760 are implemented through CPU 1. Pairing storage unit 750 is implemented through hard disk 5.

Reception unit 710 accepts input of an instruction to management server 300. In one aspect, reception unit 710 receives a request to generate a common ID for pairing the terminals and devices together. The request is transmitted to common ID generation unit 720.

Based on the request, common ID generation unit 720 generates the common ID for pairing to be used in the network system Common. ID generation runt 720 confirms whether the common ID requested to be generated has already been used, and if it has not been used, registers the requested common ID as a new common ID. The registered common ID is transmitted to common ID storage unit 730.

Common ID storage unit 730 holds the common ID generated by common ID generation unit 720. More specifically, for example, in the previously described configuration, that is, where management server 300 transmits information about a device that can he paired over the network to another device or terminal common ID storage unit 730 associates the common ID with information indentifying the network system, and holds the common ID. Pairing execution unit 740 associates a terminal ID and a device ID received by reception unit 710 with the common ID stored in common ID storage unit 730, to execute pairing of the terminal ID and the device ID.

Pairing execution unit 740 transmits a result of the execution to pairing storage unit 750.

Pairing storage unit 750 holds the association between the terminal ID and the device ID and the common ID, as pairing information about the terminal ID and the device ID.

In another aspect, reception unit 710 receives a pairing deletion request from the network system. The request is transmitted to pairing deletion unit 760.

In response to rise pairing deletion request transmitted from reception unit 710, pairing deletion unit 760 reads pairing information about the pairing requested to be deleted from pairing storage unit 750, and deletes the association between a terminal ID and a device ID that constitute the pairing information and a common ID. In another aspect, pairing deletion unit 760 deletes the common ID itself.

Based on a signal transmitted from pairing execution unit 740, transmission unit 770 transmits information about association, between a terminal and a device requested to be paired together and a common ID to the terminal and the device. In another aspect, transmission unit 770 transmits a message that pairing has been deleted to a terminal or a device that has requested the pairing deletion.

[Data Structure]

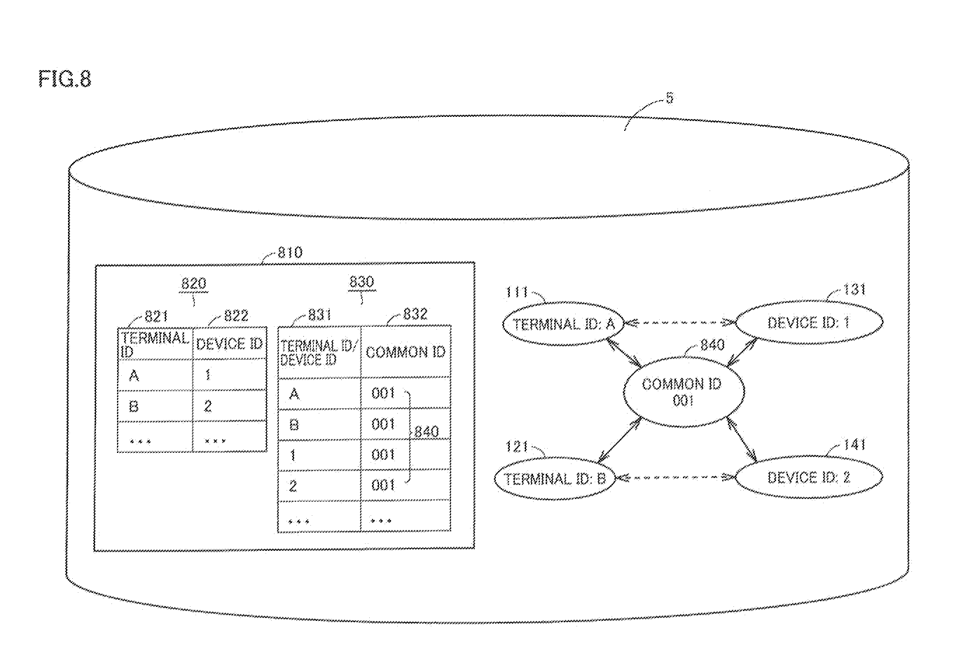

Referring to FIG. 8, a data structure of management server 300 according to this embodiment is described. FIG. 8 is a diagram conceptually illustrating one form of data stored in hard disk 5 included in management server 300.

In one aspect, hard disk 5 includes a database 810. Database 810 includes pairing information 820 and terminal device user information 830.

Pairing information 820 includes a terminal ID 821 and a device ID 822. Terminal device user information 830 includes a terminal ID or device ID 831, and a common ID 832

Here, logical relation of an ID constructed based on the data included in database 810 is described. According to database 810, a terminal ID 111 of first terminal 110, a terminal ID 121 of second terminal 120, a device ID 131 of first device 130, and a device ID 141 of second device 140 are associated with one another via a common ID 840. Common ID 840 is a value defined in a filed of common ID 832 of terminal device user information 830.

[Control Structure]

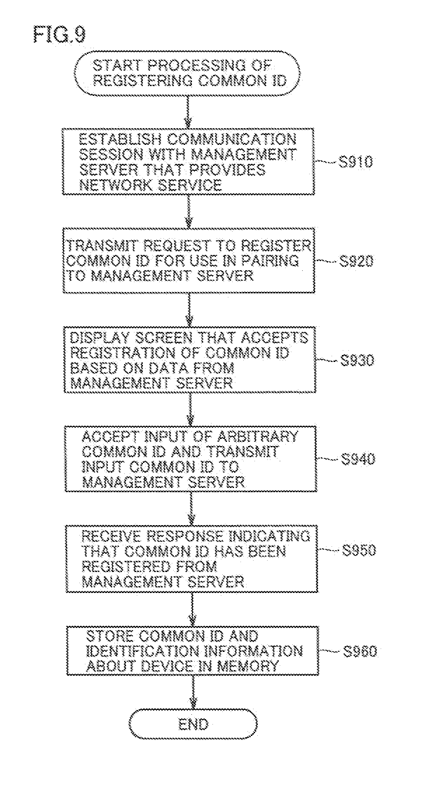

Referring to FIG. 9, processing of registering a common ID In the network system according to this embodiment is described. FIG. 9 is a flowchart illustrating part of processing executed by communication terminal 400 and management server 300.

In step S910, in response to a user's operation of communication terminal 400, CPU 20 of communication terminal 400 establishes a communication session with management server 300 that provides network service. Here, communication terminal 400 establishing the communication session may be any of first terminal 110, second terminal 120, first device 130, and second device 140.

In step S920, communication terminal 400 transmits a request to register a common ID for use in pairing in order to construct a network to management server 300 through communication circuit 24.

In step S930, monitor 35 of communication terminal 400 displays a screen that accepts registration of a common ID, based on data transmitted from management server 300.

In step S946, CPU 20 of communication terminal 400 accepts input of an arbitrary common ID by the user via operation button 25, and transmits the input common ID to management server 300. CPU 20 also stores the input, common ID in RAM 28.

In step S950, communication terminal 400 receives a response indicating that the common ID has been registered from management server 300 through communication circuit 24.

In step S960, communication terminal 400 stores the common. ID and an ID of another communication terminal which is a candidate for pairing (at least one of the first terminal, the second terminal, the first device, and the second device) in the memory.

[Display of Screen of Communication Terminal 400]

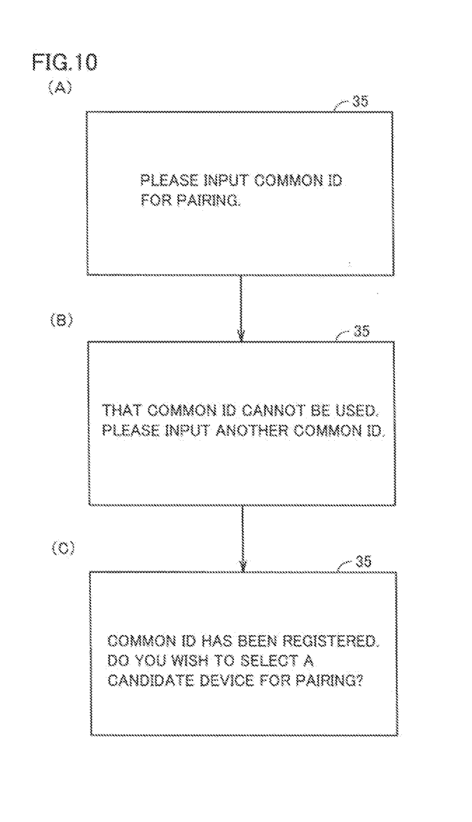

Referring to FIG. 10, a display form of a screen of communication terminal 400 according to this embodiment is described. FIG. 10 is a diagram illustrating a transition of screens displayed on monitor 35.

As shown in a state A, when a pairing registration screen is activated after a communication session is established between communication terminal 400 and management server 300, monitor 35 displays a screen, that prompts a user to input a common ID for pairing.

As shown in a state B, where the common ID input by the user of communication terminal 400 cannot be used, for example, where the common ID has already been used or includes a character or symbol that cannot be used, monitor 35 displays a message that the input common ID cannot he used and a message that another common ID should be input, based on a signal from, management server 300.

As shown in a state C, where the common ID input by the user of communication terminal 400 can be registered, monitor 35 displays a message that the input common ID has been registered and a message that prompts the user to select a device which is a candidate for pairing, based on a response from management server 300.

[Control Structure of Management Server 300]

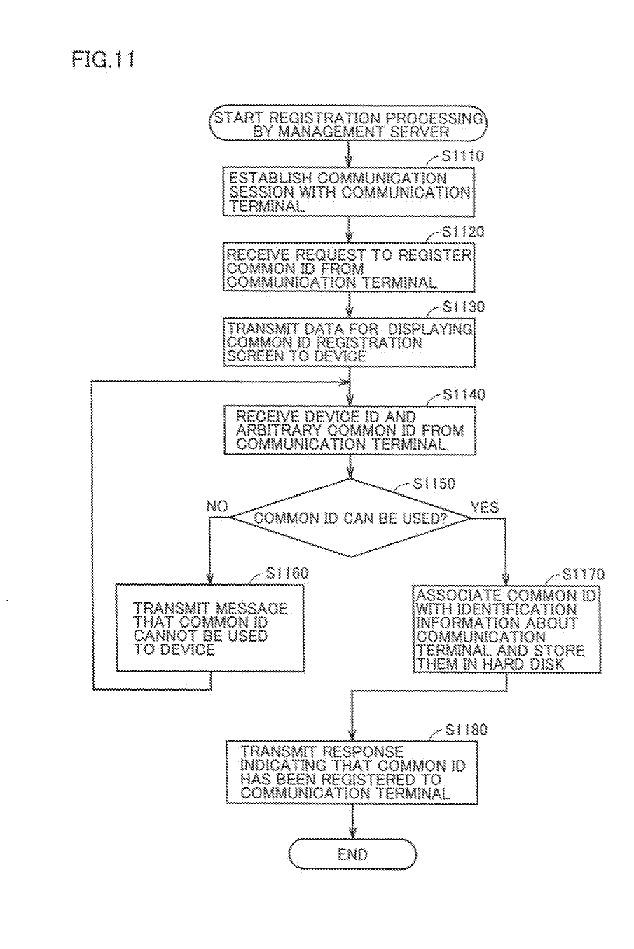

Referring to FIG. 11, a control structure of management server 300 according to this embodiment is described. FIG. 11 is a flowchart illustrating part of processing executed by management server 300 in order to register a common ID.

In step S1110, CPU 1 of management server 300 establishes a communication session with communication terminal 400 based on a signal from communication terminal 400.

In step S1120, CPU 1 receives a request to register a common ID from communication terminal 400 through communication interface 7.

In step S1130, in response to the request, CPU 1 transmits data for displaying a common ID registration screen to communication terminal 400 through, communication interface 7.

In step S1140, CPU 1 receives a device ID and an arbitrary common ID input by the user of communication terminal 400 from communication terminal 400 through communication interface 7.

In step S1150, CPU 1 determines in common ID generation unit 720 whether the received common ID can be used or not. The determination is made based on, for example, a list of common IDs that have been allocated to the communication terminal, or a list of prohibited characters defined in management server 300. When CPU 1 determines that the common ID can be used (YES in step S1150), CPU 1 switches the control to step S1170. If not (NO in step S1150), CPU 1 switches the control to step S1160.

In step S1160, CPU 1 transmits a message that the common ID cannot be used to communication terminal 400 through communication interface 7. When communication terminal 400 receives that message and the user inputs another common ID, management server 300 receives the device ID and the new common ID (step S1140).

In step S1170, CPU 1 stores information for pairing, that is, the common ID and the identification information about communication terminal 400, in hard disk 5. Hard disk 5 associates the common ID with the identification information about communication terminal 400 and stores them in common ID storage unit 730.

In step S1180, CPU 1 transmits a response indicating that the common ID has been registered to communication terminal 400 through communication interface 7. This response includes the common ID. Monitor 35 of communication terminal 400 stores the common ID in flash memory 27, and displays a message, based on the received response (see state C in FIG. 10).

[Control Structure of Communication Terminal 400]

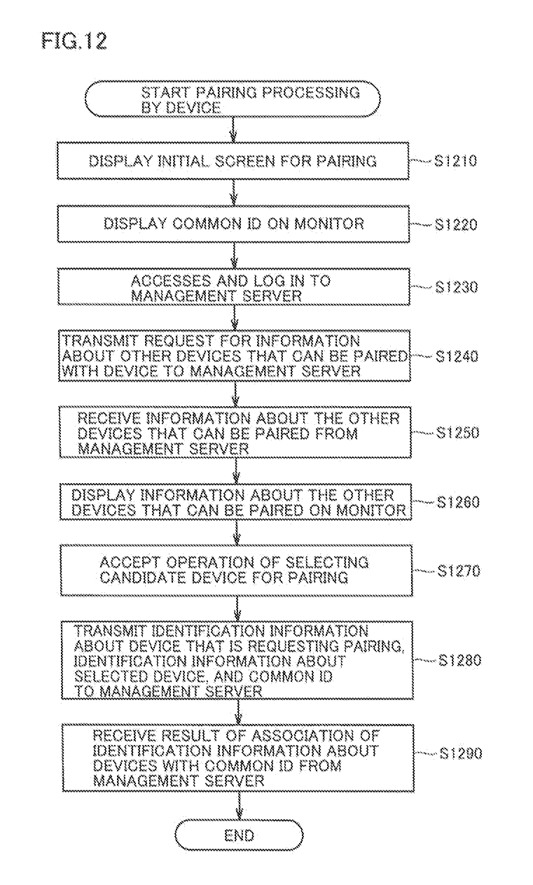

Referring to FIG. 12, a control structure of communication terminal 400 according to this embodiment is described. FIG. 12 is a flowchart illustrating part of processing executed by communication terminal 400. The following processing is executed when the user of communication terminal 400 selects pairing registration from a menu.

In step S1210, CPU 20 displays an Initial screen For pairing on monitor 33 in response to the user's operation of communication terminal 400.

In step S1220, CPU 20 displays a registered common ID on monitor 35 from flash memory 27. This common ID has been set and registered in management server 300 (step S1170).

In step S1230, CPU 20 accesses management server 300 through data communication interface 37 to transmit a user ID of and identification information about communication terminal 400 as well as a login request, and logs in to a screen for pairing processing. If the login is successful, management server 300 transmits a signal indicating that the login of communication terminal 400 has been authorized to communication terminal 400. A communication session for pairing is established between management server 300 and communication terminal 400.

In step S1240, CPU 20 transmits a request for information about other devices that can be paired with communication terminal 400 to management server 300.

In step S1250, CPU 20 receives the information about the other devices that can be paired (the names of the devices, the IDs of the devices, etc.) from management server 300. In step S1200, CPU 20 displays a list of the information about the other devices that can be paired on monitor 35, based on the information received from management server 300.

In step S1270, CPU 20 accepts operation of selecting a device or a terminal which is a candidate for pairing. This operation is performed based on, for example, operation of operation button 25 or operation of touching an icon displayed on the screen of monitor 25.

In step S1280, CPU 20 transmits the identification information about the communication terminal that is requesting the pairing, the identification information about the device selected by the user of communication terminal 400, and the common ID for pairing, to management server 300. It is noted that the timing of transmission of the identification information about the communication terminal that is requesting the pairing and the timing of transmission of the common ID are not limited to this time.

In step S1290, CPU 20 receives a result of association of the identification information, about the devices with the common ID from management server 300. More specifically, CPU 20 receives a message that the identification information about communication terminal 400 and the other device has been associated with, the common ID for pairing, and displays the received contents on monitor 35.

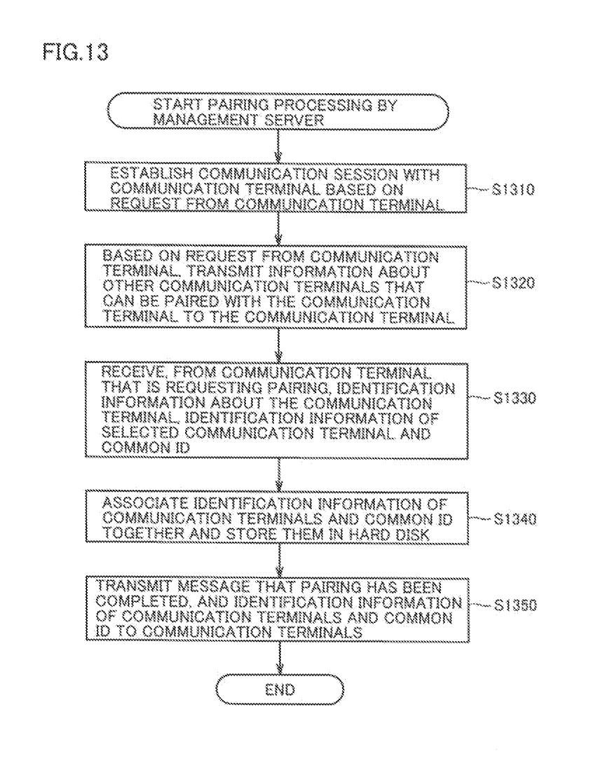

Referring to FIG. 13, the control structure of management server 300 is further described. FIG. 13 is a flowchart illustrating part of pairing processing executed by management, server 300.

In step S1310, CPU 1 of management server 300 establishes a communication session with communication terminal 400 based on a request from communication terminal 400.

In step S1320, CPU 1 transmits information about other devices that can be paired with communication terminal 400 to communication terminal 400, based on a request from communication terminal 400. Upon receiving this information, communication terminal 400 displays names and device IDs of the devices that can be paired on monitor 35 in a selectable manner.

In step S1330, CPU 1 receives, item communication terminal 400 that is requesting the pairing, the identification information about communication terminal 400, the identification information about the selected other device, the common ID, and the IP address.

In step S1340, CPU 1 associates the identification information, the common ID and the IP addresses of the devices together and stores them in hard disk 5.

In step S1350, CPU 1 transmits a message that the pairing has been completed, the identification information about the devices, and the common ID to the devices (including communication terminal 400). Thus, each device forming network system 310 can obtain information about other devices that can be paired.

[Data Reference]

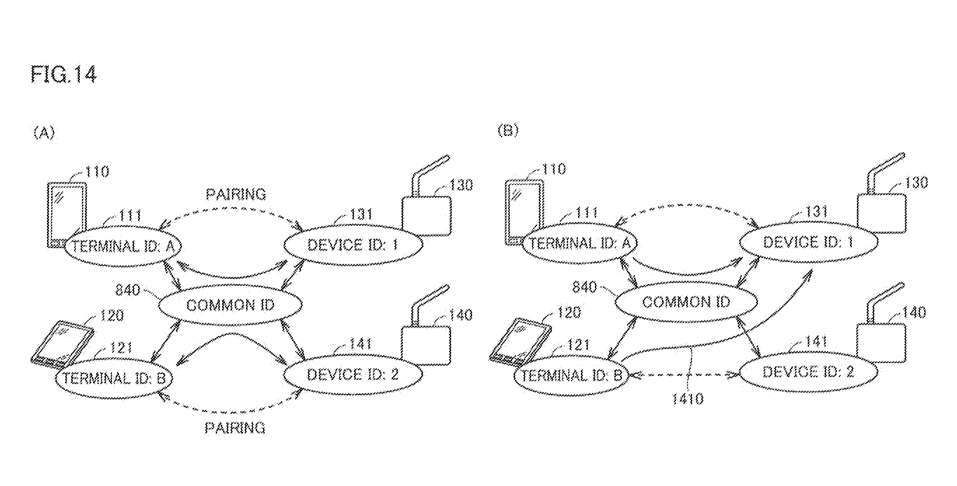

Referring to FIG. 14, data reference by paired devices is described. FIG. 14 is a diagram illustrating a form In which data is referred to via common ID 840 by a not directly paired terminal as well.

As shown in a state A, in one aspect, first terminal 110 and first device 130 are paired together by association of terminal ID 111 and device ID 131 with common ID 840. Second terminal 120 and second device 140 are paired together by association of terminal ID 121 and device ID 141 with common ID 840.

That is, while second terminal 120 and second device 140 have been paired together in the pairing process, the pairing operation has not been performed between second terminal 120 and first device 130 by the user of the second terminal or first device 130.

However, as shown in a state B, in one aspect according to this embodiment, second terminal 120 can access first device 130 that has not been directly paired with second terminal 120, as indicated by a path 1410. Second terminal 120 can thus refer to the data held in first device 130 via common ID 840.

[Control Structure]

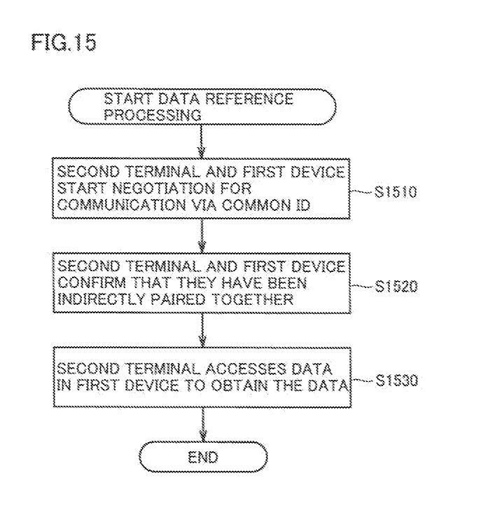

Referring to FIG. 15, processing of implementing reference to data in a device by a terminal not directly paired with the device is described. FIG. 15 is a flowchart illustrating part of processing executed between second terminal 120 and first device 130.

In step S1510, second terminal 120 and first device 130 start a negotiation for communication using common ID 840.

In step S1520, second terminal 120 and first device 130 confirm that they have been indirectly paired together based on common ID 840. More specifically, CPU 20 of second terminal 120 determines whether first device 130 is included or not in a list of pairing via common ID 840. Likewise, CPU 20 of first device 130 determines whether second terminal 120 is included or not in a list of pairing via common ID 840.

In step S1530, second terminal 120 accesses the data in first device 130 as indicated by a path 1110, and reads the data stored in flash memory 27 of first device 130.

[Pairing Deletion]

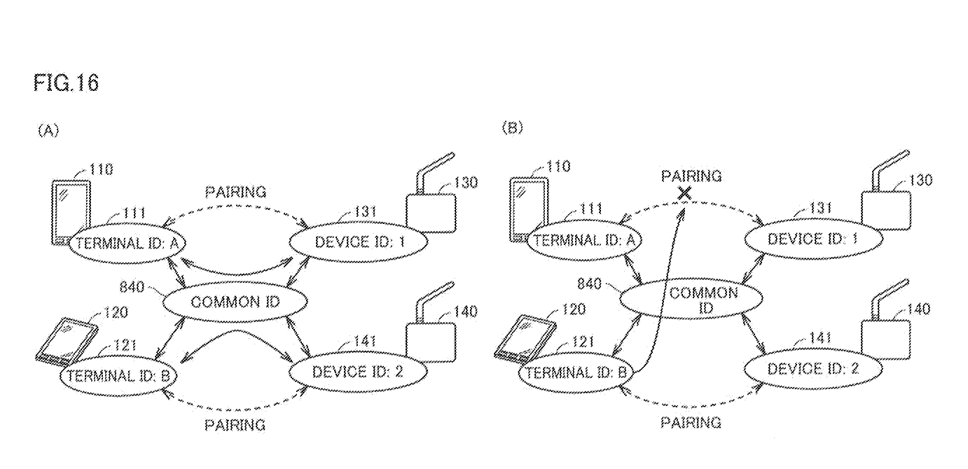

Referring to FIG. 16, deletion of pairing is described. FIG. 16 is a diagram illustrating a form in which pairing of a terminal, and a device that have been paired together is deleted.

As shown in a state A, in one aspect, first terminal 110 and first device 130 are paired together with common ID 840. Second terminal .120 and second device 140 are paired together with common ID 840. More specifically, terminal ID 111 and device ID 131 are associated with common ID 840. Terminal ID 121 and device ID 14 are associated with common ID 840.

As shown in a state B, the user of second terminal 120 can activate a menu of pairing deletion to indicate deletion of another existing pairing, for example, deletion of the pairing of first terminal 110 and first device 130. Where the device or terminal holds pairing information,, when the user of second terminal 120 inputs a deletion instruction, the association between terminal ID 111 and device ID 131 via the common ID stored in first device 130, and the association, between terminal ID 111 and device ID 131 via common ID 840 stored in first terminal 110 are deleted.

[Control Structure for Pairing Deletion in Communication Terminal 400]

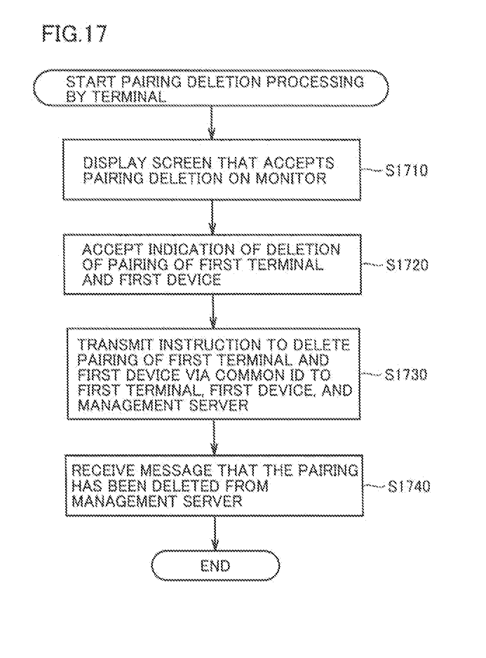

Referring to FIG. 17, a control structure that implements pairing deletion is described. FIG. 17 is a flowchart illustrating part of processing executed by second terminal 120 which is one communication terminal 400 and management server 300.

In step S1710, second, terminal 120 displays a screen that accepts pairing deletion on monitor 35.

In step S1720, second terminal 120 accepts input of an indication of deletion of the pairing of first terminal 110 and first device 130.

In step S1730, second terminal 120 transmits an Instruction to delete the pairing of first terminal 110 and first device 130 via common ID 840 to first terminal 110, first device 130, and management server 300. Based on the instruction, each of first terminal 110 and first device 130 deletes information indicating the pairing. More specifically, first terminal 110 deletes data indicating the association with first device 130 via common ID 840. First device 130 deletes data indicating the association with first terminal 110 via common ID 840. Management server 300 deletes data indicating the association between first terminal 110 and first device 130 in response to the request from second terminal 120.

In step S1740, second terminal 120 receives a message that the pairing has been deleted from management, server 300.

[Control Structure for Pairing Deletion in Management Server 300]

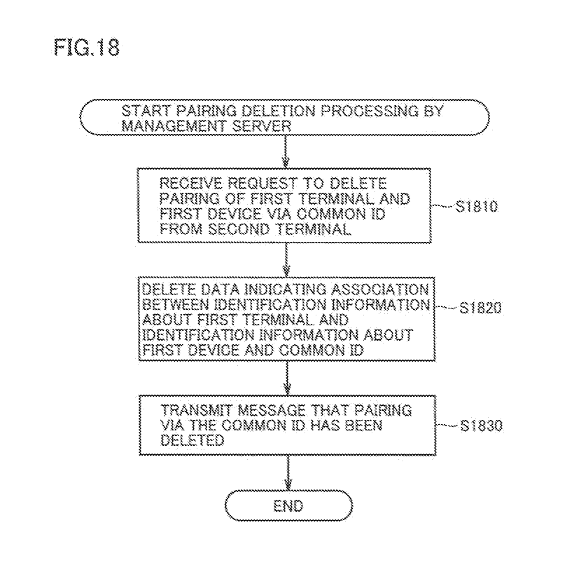

Referring to FIG. 18, a control structure of management server 300 that deletes pairing is described. FIG. 18 is a flowchart illustrating part of processing executed by CPU 1 of management server 300.

In step S1810, management server 300 receives a request to delete the pairing of first terminal 110 and first device 130 via common ID 840 from second terminal 120.

In step S1820, CPU 1 of management server 300 deletes data indicating the association between the identification information about first terminal 110 and the identification information about first device 130 (i.e., terminal ID 111 and device ID 131) and common ID 840.

In step S1830, management server 300 transmits a message that the pairing via common ID 840 has been deleted to second terminal 120. Management server 300 also transmits a message that the pairing of first terminal 110 and first device 130 has been deleted at the request of second terminal 120, to first terminal 110 and first device 130.

### Embodiment 2

Although a single common ID is illustrated as the ID for pairing to the example shown in FIG. 8, common IDs for a plurality of pairings may be used in the same household. In this case, for example, each user may have the respective common IDs. Thus, pairing for each individual can he readily managed.

Since the configuration other than, the previously described configuration, that is, the configurations of management server 300 and communication terminal 400 and the overall configuration of the network system used in Embodiment 2 are the same as those of Embodiment 1, the description thereof is not repeated.

### Embodiment 3

Instead of the process shown in step S1130, the data for displaying a registration screen may be previously held in communication terminal 400 as an application program. According to such a configuration, the user of communication terminal 400 can input a common ID even where a communication session with management server 300 has not been established.

Since the configuration other than the previously described configuration, that is, the configurations of management server 300 and communication terminal 400 and the overall configuration of the network system used in Embodiment 3 are the same as those of Embodiment 1, the description thereof is not repeated.

### Embodiment 4

Regarding the deletion of pairing, instead, of the form shown in FIG. 16, in another aspect, a signal indicating that the pairing of first terminal 110 and first device 130 is to be disabled may be transmitted from second terminal 120 to management server 300. Upon receiving this signal, management server 300 sets a flag that disables the association between terminal ID 111 and device ID 131 via common ID 840, and transmits a signal indicating that the association has been disabled to first terminal 110 and first device 130.

Upon receiving the signal from management server 300, first terminal 110 deletes data defining the pairing with first device 130 (the association between terminal ID 111 and device ID 131 via common ID 840). Likewise, upon receiving the signal from management server 300, first device 130 deletes data defining the pairing with first terminal 110 (the association between terminal ID 111 and device ID 131 via common ID 840). Thus, the pairing of first terminal 110 and first device 130 is deleted based on the operation of second terminal 120.

Since the configuration other than the previously described configuration, that is, the configurations of management server 300 and communication terminal 400 and the overall configuration of the network system used in Embodiment 4 are the same as those of Embodiment 1, the description thereof is not repeated.

### Embodiment 5

[Data Structure of Management Server 300]

In another aspect, the configuration may be such that only communication terminal 400 authorized to delete pairing can delete pairing.

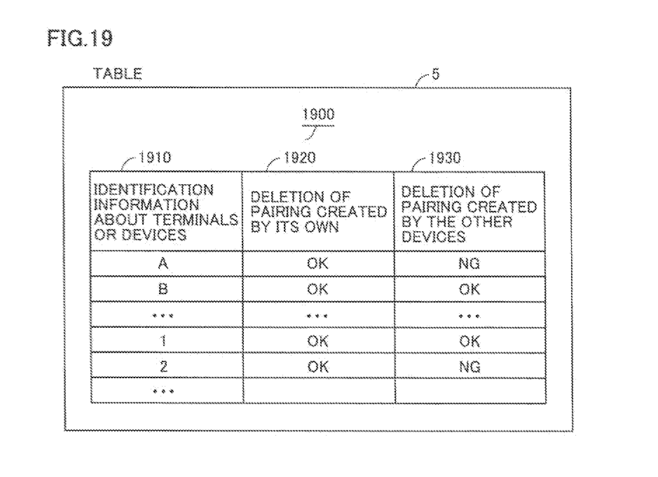

Thus, referring to FIG. 19, a data structure of management server 300 is described. FIG. 19 is a diagram illustrating authority regarding deletion of pairing.

In one aspect, hard disk 5 of management server 300 includes a table 1900. Table 1900 includes identification information about terminals or devices 1910, management information for controlling whether paring created by the terminal itself can be deleted or not 1920, and data for controlling whether pairing created by the other terminals or devices can be deleted or not 1930. For example, first terminal 110 having identification information of “A” is authorized to cancel pairing created by first terminal 110 Itself (1920). On the other hand, first terminal 110 cannot delete pairing created by the other devices (1930).

The use of such an authority table can prevent unintended deletion of pairing.

Since the configuration other than the previously described configuration, that is, the configurations of management server 300 and communication terminal 400 and the overall configuration of the network system used in this embodiment are the same as those of Embodiment 1, the description thereof is not repeated.

### Embodiment 6

[Collective Deletion of Pairings]

In another aspect, pairings may be collectively deleted.

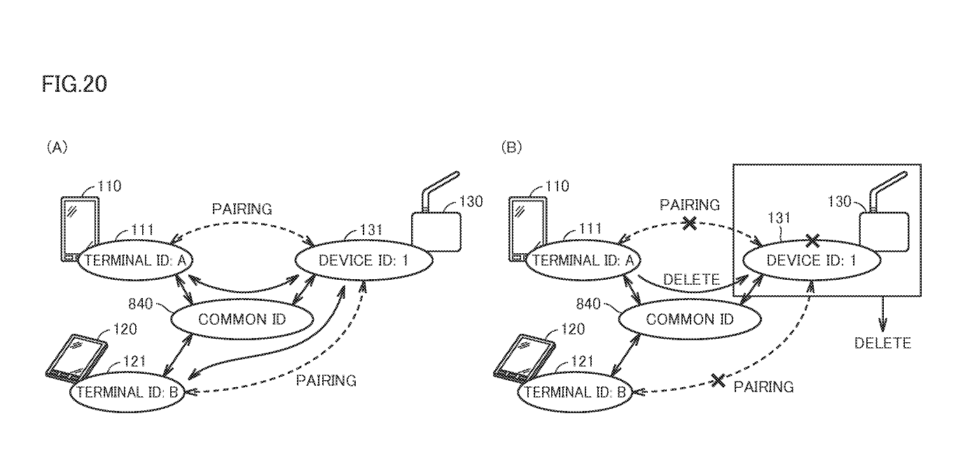

Thus, referring to FIG. 20, collective deletion of pairings is described. FIG. 20 is a diagram illustrating a form in which pairings are collectively deleted in a paired state.

As shown in a state A, in one aspect, first terminal 110, second terminal 120, and first device 130 are paired with one another via common ID 840. Specifically, terminal IDs 111, 121 and device ID 131 are associated with common ID 840.

As shown in a state B, in one aspect, first device 130 is deleted from the network configuration. For example, first device 130 is physically ruled out as candidates for pairing by being discarded. Here, upon detecting that first device 130 has been deleted from the network, management server 300 searches for pairings associated with device ID 131 of first device 130, and deletes all the retrieved associations. Thus, following the deletion of first device 130 front pairing, the associated pairings can be collectively deleted.

Since the configuration other than the previously described configuration, that is, the configurations of management server 300 and communication terminal 400 and the overall configuration of the network system used in this embodiment are the same as those of Embodiment 1, the description thereof is not repeated.

[Control Structure]

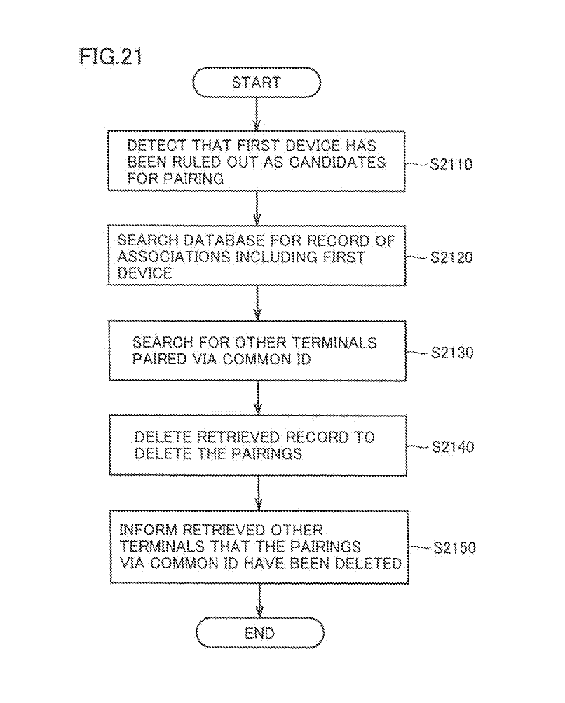

Referring to FIG. 21, a control structure of management server 300 is described. FIG. 21 is a flowchart illustrating part of processing executed by management server 300 in order to delete pairing.

In step S2110, CPU 1 detects that first device 130 has been ruled out as candidates for pairing based on a result of polling or operation of deleting first device 130.

In step S2120, CPU 1 searches the database stored in hard disk 5 for a record of associations including first device 130.

In step S2130, CPU 1 searches for other terminals paired with first device 130 via common ID 840. For example, first terminal 110 and second terminal 120 are retrieved.

In step S2140, CPU 1 deletes the retrieved record to delete all the pairings associated with first device 130.

In step S2150, CPU 1 informs the retrieved other terminals that the pairings via common ID 840 have been deleted. Thus, first terminal 110 and second terminal 120, for example, can learn that their pairings with first device 130 via common ID 840 have been deleted.

[Display Form of Screen]

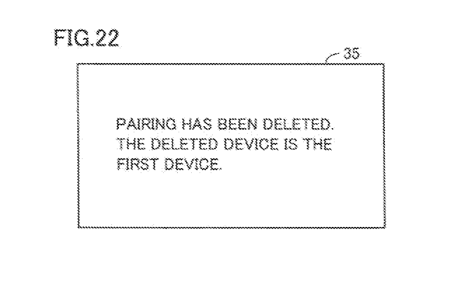

Referring to FIG. 22, a screen displayed on communication terminal 400 is described. FIG. 22 is a diagram illustrating one example of a screen displayed on monitor 35. In one aspect, communication terminal 400 receives a message that pairing has been deleted from management server 300. For example, first terminal 110 and second terminal 120 receive a message that their pairings with first device 130 have been deleted. Here, monitor 35 displays the message that the pairing has been deleted, and a device that cause the pairing deletion. Thus, the users of the other communication terminals 400 can readily learn which device has been deleted to cause the pairing deletion.

### Embodiment 7

A form of detecting terminals or devices that can be paired is not limited to the previously described configuration, that is, the configuration, where management server 300 has information, about the terminals or devices that can be paired. For example, management server 300 may broadcast an inquiry to all nodes (devices or terminals) in the same network forming network system 310, or any of all the nodes may broadcast an Inquiry. A device or a terminal, that responds to such an inquiry may be held in management server 300, or in the device or the terminal that made an inquiry, as a device or a terminal that can be paired.

It is noted that since the hardware configuration and the other configurations are the same as those In the previously described embodiments, the description, thereof is not repeated.

### Embodiment 8

Regarding the data held in common ID storage unit 730 of management server 300, in another embodiment, where a device or a terminal inquires about the presence of other devices or terminals that can be paired by broadcast transmission, the common ID may not he associated with the information indentifying the network system. It is noted that since the hardware configuration and the other configurations are the same as those in the previously described embodiments, the description thereof is not repeated.

### Embodiment 9

Regarding the process of step S1250, in another embodiment, the determination of whether the device is a device that can be paired or not may be made based on whether the device is connected to the same network to which a device (or terminal) that is requesting the pairing is connected or not. In this case, the determination is made as follows, for example. (1) CPU 20 of the device (or terminal) that requests the pairing sends an inquiry (e.g., broadcasts an inquiry) to terminals within the same network, to obtain IDs of the devices connected to the same network. (2) The above CPU 20 sends an inquiry to management server 300 about information on the devices found on the same network based on the IDs of the devices, and receives information about the devices transmitted from management server 300 in response to the inquiry. It is noted that since the hardware configuration and the other configurations are the same as those in the previously described embodiments, the description thereof is not repeated.

### Embodiment 10

In another embodiment, it is conceivable, for example, that a terminal or a device that requests pairing sends an inquiry by broadcast transmission within, the same network to which the device or the terminal is connected, and requests to management server 300 for pairing by using IDs of the other devices obtained as a result of the inquiry. In this case, the reception of the IP address in the process of step S1330 is unnecessary. It is noted that since the hardware configuration and the other configurations are the same as those in the previously described embodiments, the description thereof is not repeated.

### Embodiment 11

Regarding the process shown in FIG. 15, in another embodiment data reference may be made through management server 300. For example, management server 300 may previously hold data obtained from paired devices or terminals, and upon receiving a request for data reference from a terminal, management server 300 may confirm whether the terminal that has transmitted, the request is paired with a terminal holding the data via a common ID. Such a configuration can control whether the data can be referred to or not, thus preventing illegal data reference by an unauthorized terminal (or terminal), that is, an unpaired terminal or device. It is noted that since the hardware configuration and the other configurations are the same as those in the previously described embodiments, the description thereof is not repeated.

### Embodiment 12

The processing in the wireless communication, system according to the previously described embodiments has been described as an example in which a CPU in a computer having a well-known configuration executes instructions in a program. In another embodiment, the wireless communication system may be implemented as a combination of circuit elements or other devices executing the instructions.

### Summary of Embodiments

As has been previously described, the network system according to the embodiments facilitates pairing and deletion of pairing of a terminal or device and another terminal or device. Consequently, the convenience of the user of the network system is increased.

Furthermore, since a common ID is required for pairing, other terminals or devices that have not been informed of the common ID (e.g., a wireless communication terminal owned by a third party outside a house) cannot be paired, thus inhibiting unintended leakage of information.

It is noted that each of the previously described embodiments may be appropriately combined with the features described in the other embodiments.

The contests disclosed in the present specification cat) be, in one aspect, summarized as follows.

[Configuration 1]

A wireless communication system comprising:

a plurality of devices connected to a network; and

a management server connected to the network,

the management server including
a reception unit configured to receive identification information about a first device and identification information about a second device of the plurality of devices, pairing Identification information for specifying pairing of the first device and the second device, and a pairing request, and
a pairing unit configured to associate, based on the pairing request, the pairing identification information with the identification information about the first device and the Identification information about the second device.

[Configuration 2]

The wireless communication system according to Configuration 1, wherein

the management server further includes a transmission unit configured to transmit information about a device that can be paired with the first device to the first device.

[Configuration 3]

The wireless communication system according to Configuration 1 or 2, wherein

the first device further includes a broadcast unit configured to broadcast an. inquiry about a device that can be paired with the first device to the other devices of the plurality of devices.

[Configuration 4]

The wireless communication system according to Configuration 2 or 3, wherein

where the second device is the device that can be paired, the pairing unit associates the pairing identification information with the identification information about the first device and the identification information about the second device.

[Configuration 5]

The wireless communication system according to any of Configurations 1 to 4, wherein

the reception unit receives a network address of the first device, and

where the first device and the second device exist in the same network, the pairing unit associates the pairing identification information with the identification information about the first device and the identification information about the second device.

[Configuration 6]

The wireless communication system according to any of Configurations 1 to 5, wherein

the management server further includes a pairing deletion, unit configured to cancel the association, between the pairing identification information, and the identification information about the first device and the identification information about the second device.

[Configuration 7]

The wireless communication system according to Configuration 6, wherein

where another one of the plurality of devices and the second device have been paired together via the pairing identification information, the pairing deletion unit cancels the pairing of the another device and the second device.

[Configuration 8]

A pairing apparatus for associating a plurality of devices together, comprising:

a reception unit configured to receive identification information about a first device and identification information about a second device of the plurality of devices connected to a network, pairing identification information for specifying pairing, and a pairing request; and

a pairing unit configured to associate, based on the pairing request, the pairing identification information with the identification information about the first device and the identification information about the second device.

[Configuration 9]

The pairing apparatus according to Configuration 8, further comprising a transmission unit configured to transmit information about a device that can be paired with the first device to the first device.

[Configuration 10]

The pairing apparatus according to Configuration 8 or 9, further comprising a broadcast unit configured to broadcast an inquiry about a device that can be paired with the first device to the other devices of the plurality of devices.

[Configuration 11]

The pairing apparatus according to Configuration 9 or 10, wherein

where the second device is the device that can be paired, the pairing unit associates the pairing identification information with the identification information about the first device and the identification information about the second device.

[Configuration 12]

The pairing apparatus according to any of Configurations 8 to 11, wherein

the reception unit receives a network address of the first device, and

where the first device and the second device exist in the same network, the pairing unit associates the pairing identification information with the identification information about the first device and the identification information about the second device.

[Configuration 13]

The pairing apparatus according to any of Configurations 8 to 12, further comprising a pairing deletion unit configured to cancel the association between the pairing identification Information, and the identification information about the first device and the identification information about the second device.

[Configuration 14]

The pairing apparatus according to Configuration 13, wherein

where another one of the plurality of devices and the second device have been paired together via the pairing identification information, the pairing deletion unit cancels the pairing of the another device and t he second device.

[Configuration 15]

A method for pairing a plurality of devices together by a processor, comprising the steps of:

receiving identification information about each of the devices;

associating data common to the devices with identification information about each of two of the plurality of devices; and

transmitting information indicating the association between the common data and the identification information about each of the two devices to the two devices.

[Configuration 16]

A program for causing one or more processors to implement a method for pairing a plurality of devices together, the program causing the one or more processors to perform the steps of:

receiving identification information about each of the devices;

associating data common to the devices with identification information about each of two of the plurality of devices; and

transmitting information indicating the association between the common data and the identification information shout each of the two devices to the two devices.

Although the present invention has been described and illustrated in detail, it is clearly-understood that the same is by way of illustration and example only and is not to be taken by way of limitation, the scope of the present invention being interpreted by the terms of the appended claims.

### REFERENCE SIGNS LIST

1, 20 CPU; 2 mouse; 3 keyboard; 4, 28 RAM; 5 hard disk; 6 optical disk drive; 7 data communication interface; 8, 35 monitor; 9 CD-ROM; 100, 200, 310 network system; 23 antenna; 24 communication circuit, 25 operation button; 27 flash memory; 29 ROM; 36 LED; 37 communication interface; 110 first terminal; 120 second terminal; 130 first device; 140 second device; 200 server device; 300 management server; 320 access point; 400 communication terminal; 500 list; 710 reception unit; 720 generation unit; 730 storage unit; 740 pairing execution unit; 750 pairing storage unit; 760 pairing deletion unit; 770 transmission unit; 810 database; 820 pairing information; 830 terminal/device user information; 1110, 1410 path; 1900 table; 1910 identification information; 1920 management information; 1930 data.

1-5. (canceled)

6. A wireless communication system comprising:
a plurality of devices connected to a network; and
a management server connected to said network,
said management server including
a transmission module for transmitting, in response to a request from a first device of said plurality of devices, identification information about a pairable second device of said plurality of devices to said first device,
a receiver module for receiving the identification information about said second device that has been selected as a candidate for pairing with said first device, and identification information about said first device, from said first device, and
a pairing module for associating common data associated with the identification information about said first device with the identification information about said second device.

7. A pairing apparatus for associating a plurality of devices together, comprising:
a transmission module for transmitting, in response to a request from a first device of said plurality of devices, identification information about a pairable second device of said plurality of devices to said first device;
a receiver module for receiving the identification information about said second device that has been selected as a candidate for pairing with said first device, and identification information about said first device, from said first device, and
a pairing module for associating common data associated with the identification information about said first device with the identification information about said second device.

8. The pairing apparatus according to claim 7, further comprising a broadcast module for broadcasting an inquiry about a device that can be paired with said first device to the other devices of said plurality of devices.

9. A method for pairing a plurality of devices together by a processor, comprising of:
transmitting, in response to a request from a first device of said plurality of devices, identification information about a pairable second device of said plurality of devices to said first device;
receiving the identification information about said second device that has been selected as a candidate for pairing with said first device, and identification information about said first device, from said first device; and
associating common data associated with the identification information about said first device with the identification information about said second device.

10. A non-transitory recording medium stored thereon a program for causing one or more processors to implement a method for pairing a plurality of devices together, said program causing said one or more processors to perform:
transmitting, in response to a request from a first device of said plurality of devices, identification information about a pairable second device of said plurality of devices to said first device;
receiving the identification information about said second device that has been selected as a candidate for pairing with said first device, and identification information about said first device, from said first device; and
associating common data associated with the identification information about said first device with the identification information about said second device.
